(19) United States
(12) Patent Application Publication
(10) Pub. No.: US 2025/0232409 A1
(43) Pub. Date: Jul. 17, 2025

(54) RADIOGRAPHIC IMAGING APPARATUS, RADIOGRAPHIC IMAGING SYSTEM, METHOD FOR RADIOGRAPHIC IMAGING APPARATUS, AND STORAGE MEDIUM

(71) Applicant: CANON KABUSHIKI KAISHA, Tokyo (JP)

(72) Inventor: HIROYUKI TANAKA, Kanagawa (JP)

(21) Appl. No.: 19/017,083

(22) Filed: Jan. 10, 2025

(30) Foreign Application Priority Data
Jan. 17, 2024 (JP) 2024-005405

(51) Int. Cl. G06T 5/50; G01T 7/00; G06T 5/70

(52) U.S. Cl. CPC G06T 5/50; G01T 7/005; G06T 5/70; G06T 2207/10116; G06T 2207/20216

(57) ABSTRACT

A radiographic imaging apparatus includes at least one processor and a memory in communication with the at least one processor, the memory storing instructions that, when executed by the at least one processor, cause the at least one processor to function as an image acquisition unit that alternately acquires a radiation image acquired in a state where radiation is emitted and an offset image acquired in a state where the radiation is not emitted and an offset correction unit that corrects, in a case where a change amount between an offset image acquired at a first time and an offset image acquired at a second time before the first time is smaller than a first threshold value, a radiation image acquired after the first time using a plurality of offset images including the offset image acquired at the first time and the offset image acquired at the second time.

### BACKGROUND

### Field

The present disclosure relates to a radiographic imaging apparatus, a radiographic imaging system, a processing method for the radiographic imaging apparatus, and a storage medium.

### Description of the Related Art

A radiographic imaging apparatus that can display a radiation image in real time has been in widespread use as a radiographic imaging apparatus for capturing a radiation image using radioactive rays (e.g., X rays) that passes through an object. Further, a radiographic imaging apparatus that uses a flat panel detector (FPD) is proposed.

The FPD includes minute radiation detectors, each of which is formed by laminating a solid-state light detector and a scintillator, arranged on a quartz glass substrate in a matrix. The solid-state light detector includes an amorphous semiconductor sandwiched between a transparent conductive film and a conductive film. The scintillator converts radiation into visible light. As the solid-state light detector, a charge-coupled device (CCD) light detector and a complementary metal-oxide semiconductor (CMOS) light detector are known. As the radiation detector, a radiation detector configured to directly detect the radioactive rays by the solid-state light detectors without using the scintillator is known.

The FPD detects an amount of radiation emitted during an accumulation time as an amount of charge. Thus, when a radiation image of an object is captured, in a case where an electric charge irrelevant to irradiation with radiation is present in the radiation detector, the charge is superimposed on the radiation image as noise, which causes a deterioration of image quality of the radiation image.

An example of a charge that causes noise is a residual electric charge that remains based on characteristics of the solid-state light detector and the scintillator after capturing of a previously captured radiation image. Further, another example of the electric charge that causes noise is a dark current caused by an electric charge generated in the solid-state light detector mainly due to an influence of temperature. In addition, the quality of the radiation image deteriorates due to a fixed noise caused by an intrinsic defect of the radiation detector.

When a radiation image of an object is captured, a residual electric charge and a dark current component charge are accumulated in proportion to the accumulation time of the image during which irradiation with radiation is performed, and the image quality of the radiation image deteriorates. Thus, in the radiation image capturing of the object, an offset correction is performed to correct offset components caused by the residual electric charge accumulated during the image capturing, the dark current charge, and the fixed noise. In general, the offset correction is performed in such a manner that an image (non-exposure image) acquired by capturing the image in a state where the radiation is not emitted is used as an offset image, and the offset image is subtracted from the radiation image.

There is a plurality of methods of such an offset correction method. For example, there is a method (fixed offset correction) of correcting the offset by (1) subtracting, from the radiation image, non-exposure image data acquired before capturing of a radiation image of an object as an offset image.

There is another method (intermittent offset correction) of correcting the offset by (2) alternately capturing a radiation image of an object and acquiring a non-exposure image (offset image) and subtracting the offset image from the radiation image.

Here, the characteristics of the methods (1) and (2) are described. By the method (1), it is possible to reduce random noise because a plurality of offset images is acquired and averaged before capturing of the radiation image of the object. Accordingly, it is possible to capture the radiation image with a low dose.

However, by the method (1), since the offset images are acquired before irradiation with the radiation, the image lag cannot be sufficiently corrected, which is an issue. Further, the dark current charge accumulated during the image capturing changes due to influences of temperature of the radiation detector, an image capturing condition, or a time degradation of a sensor. Therefore, in the case where the offset images are acquired before capturing of the radiation image of the object as in the method (1), the accuracy of the offset correction cannot be sufficiently obtained, which is an issue.

By the method (2), it is possible to reduce the image lag because capturing of the radiation image of the object and acquiring of the non-exposure image (offset image) are alternate performed, and the non-exposure image including the image lag is subtracted from the radiation image. However, by the method (2), since one non-exposure image is subtracted from the radiation image, the random noise is large, which is an issue.

As a technique for ensuring accuracy of the offset correction, Japanese Patent Application Laid-open No. 2018-157939 discusses a technique. Specifically, Japanese Patent Application Laid-open No. 2018-157939 discusses a technique of selecting a most suitable offset correction method based on whether a stabilization mechanism that suppresses a temperature change of the FPD effectively functions.

In a case where the technique discussed in Japanese Patent Application Laid-open No. 2018-157939 is applied to a radiographic imaging apparatus, it is possible to optimize the offset correction method by switching between the fixed offset correction and the intermittent offset correction depending on the situation. However, a reduction of the random noise, which is the issue in the intermittent offset correction, is not solved.

### SUMMARY

The present disclosure is directed to a technique for performing an offset correction that can reduce an image lag and random noise.

According to an aspect of the present disclosure, a radiographic imaging apparatus includes at least one processor, and a memory in communication with the at least one processor, the memory storing instructions that, when executed by the at least one processor, cause the at least one processor to function as an image acquisition unit configured to alternately acquire a radiation image acquired in a state where radiation is emitted and an offset image acquired in a state where the radiation is not emitted and an offset correction unit configured to correct, in a case where a change amount between an offset image acquired at a first time and an offset image acquired at a second time before the first time is smaller than a first threshold value, a radiation image acquired after the first time using a plurality of offset images including the offset image acquired at the first time and the offset image acquired at the second time.

Further features of the present disclosure will become apparent from the following description of exemplary embodiments with reference to the attached drawings.

### BRIEF DESCRIPTION OF THE DRAWINGS

FIG. 1 is a block diagram illustrating a configuration example of a radiographic imaging system.

FIG. 2 is a diagram illustrating an intermittent offset correction in moving image capturing.

FIG. 3 is a diagram illustrating an averaging intermittent offset correction in moving image capturing.

FIG. 4 is a flowchart illustrating a processing procedure of the averaging intermittent offset correction.

FIG. 5 is diagram illustrating the averaging intermittent offset correction method over five frames.

FIG. 6 is a diagram illustrating determination of magnitude of a change amount of an immediately-after-imaging offset image.

FIG. 7 is a diagram illustrating weighting and averaging.

### DESCRIPTION OF THE EMBODIMENTS

Hereinbelow, exemplary embodiments will be described with reference to the attached drawings.

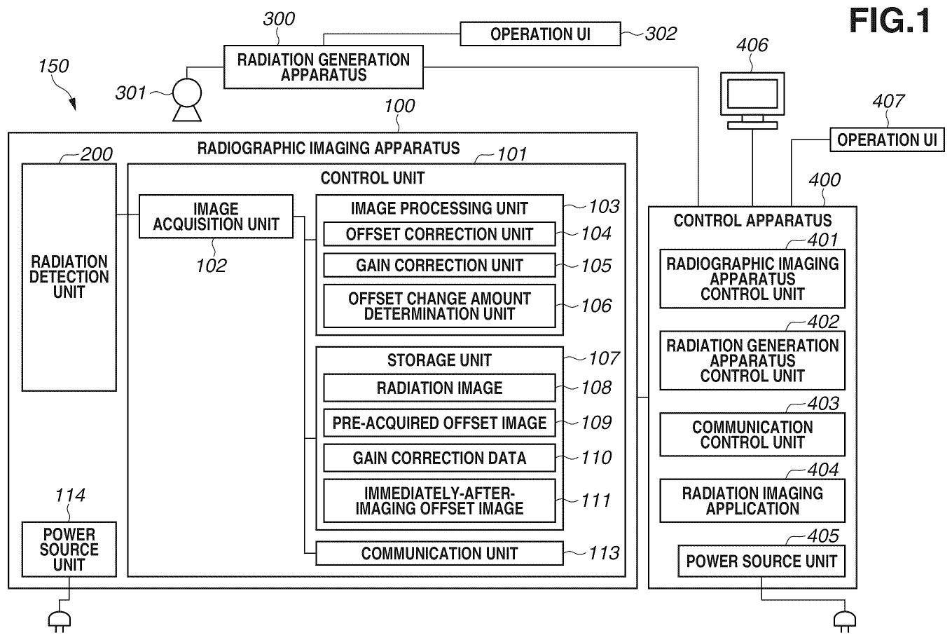

FIG. 1 is a block diagram illustrating a configuration example of a radiographic imaging system 150 according to a first exemplary embodiment. The radiographic imaging system 150 includes a radiographic imaging apparatus 100, a radiation generation apparatus 300, a radiation source 301, an operation user interface (UI) 302, a control apparatus 400, a display unit 406, and an operation UI 407.

The radiographic imaging apparatus 100 includes a radiation detection unit 200. The radiation source 301 emits radiation. The radiation generation apparatus 300 controls the radiation source 301. The operation UI 302 is connected to the radiation generation apparatus 300. The radiation includes α rays, β rays, γ rays, and various kinds of particle rays, in addition to X rays.

The control apparatus 400 has a radiation imaging application 404. The radiation imaging application 404 controls the radiographic imaging apparatus 100 and the radiation generation apparatus 300 to collect a captured image from the radiographic imaging apparatus 100 and display it.

The radiographic imaging apparatus 100 includes a control unit 101, a power source unit 114, and the radiation detection unit 200. The control unit 101 controls imaging and communications. The radiation detection unit 200 detects radiation to generate image data.

The radiation detection unit 200 includes a two-dimensional image sensor and a scintillator, and the scintillator converts radiation (e.g., X rays) that has reached the radiation detection unit 200 into light. Then, the image sensor detects a two-dimensional distribution of the light converted by the scintillator to generate radiation image data.

The radiation detection unit 200 is a flat panel detector (FPD). In the present exemplary embodiment, assume that the scintillator emits light in proportion to the intensity of the received radiation, and the image sensor outputs pixel values in proportion to the light emission intensity of the scintillator, for example.

The control unit 101 includes an image acquisition unit 102 that acquires a radiation image from the radiation detection unit 200, an image processing unit 103, a storage unit 107, and a communication unit 113.

The image acquisition unit 102 reads a charge from each pixel of the image sensor of the radiation detection unit 200, and when the reading of charges from all pixels of the image sensor is completed, acquisition of the radiation image is completed. The image acquisition unit 102 stores an acquired radiation image 108 into the storage unit 107.

The image processing unit 103 includes an offset correction unit 104, a gain correction unit 105, and an offset change amount determination unit 106.

The offset correction unit 104 performs an offset correction on the radiation image 108 that is acquired by the image acquisition unit 102 and stored in the storage unit 107. The gain correction unit 105 performs gain correction. The offset change amount determination unit 106 determines magnitude of a change amount in an immediately-after-imaging offset image 111.

In addition, the image processing unit 103 may include a correction unit for performing correction processing other than those described above. Further, the offset correction unit 104 may also perform generation processing of an offset image. Further, the gain correction unit 105 may perform generation processing of gain correction data 110.

The storage unit 107 stores the radiation image 108 acquired by the image acquisition unit 102, and a pre-acquired offset image 109 used when an offset correction is performed on the radiation image 108. In the present exemplary embodiment, assume that the pre-acquired offset image 109 is an image generated in advance before image capturing. The number of pre-acquired offset images 109 is not limited to one, and the pre-acquired offset image 109 may be stored, for example, for each size of a captured image or each radiation accumulation time when the image is captured.

Further, the storage unit 107 stores the gain correction data 110 that is generated in advance by the gain correction unit 105. The number of pieces of the gain correction data 110 is not limited to one, and the gain correction data 110 may be stored, for example, for each size of a captured image when the image is captured.

Further, the storage unit 107 stores the immediately-after-imaging offset image 111. The immediately-after-imaging offset image 111 is an image captured by the image acquisition unit 102 under a radiation non-exposure state immediately after radiographic imaging.

The control apparatus 400 includes a radiographic imaging apparatus control unit 401, a radiation generation apparatus control unit 402, a communication control unit 403, the radiation imaging application 404, and a power source unit 405. The radiation generation apparatus 300, the display unit 406, and an operation UI (keyboard, mouse, or the like) 407 are connected to the control apparatus 400.

The radiographic imaging apparatus control unit 401 controls an image acquisition timing and an image acquisition condition of the radiographic imaging apparatus 100. The radiation generation apparatus control unit 402 controls a radiation irradiation condition or the like of the radiation generation apparatus 300. The communication control unit 403 controls communications with the radiographic imaging apparatus 100 and the radiation generation apparatus 300. The radiation imaging application 404 is as described above.

The display unit 406 displays a captured image and image-capturing information. The operation UI 407 is a UI for operating the radiation imaging application 404.

Information communications are possible between the control apparatus 400 and the radiographic imaging apparatus 100 and between the control apparatus 400 and the radiation generation apparatus 300 by any one means or a plurality of means of a cable-connected communication using a standard such as Recommended Standard (RS) 232C, universal serial bus (USB), and Ethernet, a dedicated signal line communication, and a wireless communication.

Between the control apparatus 400 and the radiographic imaging apparatus 100, control communications of, for example, image data, an image acquisition condition setting, and an apparatus status acquisition are performed. Further, between the control apparatus 400 and the radiation generation apparatus 300, control communications of, for example, a radiation irradiation condition setting, an apparatus status acquisition, and actual irradiation information are performed.

The radiation generation apparatus 300 controls the radiation source 301 to generate radiation. The radiographic imaging apparatus 100 is communicably connected with the radiation generation apparatus 300 via the control apparatus 400.

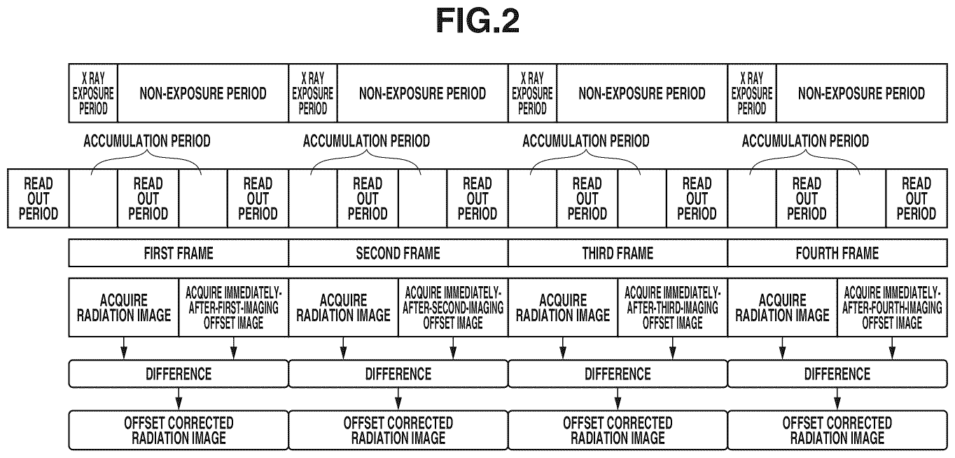

FIG. 2 is a diagram illustrating an intermittent offset correction performed by the radiographic imaging apparatus 100. The intermittent offset correction is a correction method of alternately acquiring the radiation image 108 and the immediately-after-imaging offset image 111 that is acquired immediately after the radiation image 108 for each frame in capturing a moving image, taking a difference between the above-described two images by the offset correction unit 104, and generating an offset corrected radiation image.

For each frame, the image acquisition unit 102 acquires the radiation image 108 generated by the radiation detection unit 200 when radiation (X rays) is emitted, and the immediately-after-imaging offset image 111 generated immediately after generation thereof by the radiation detection unit 200 when the radiation (X rays) is not emitted.

Then, the image acquisition unit 102 stores the acquired radiation image 108 and the immediately-after-imaging offset image 111 in the storage unit 107.

The offset correction unit 104 generates a difference between the radiation image 108 and the immediately-after-imaging offset image 111 for each frame as an offset corrected radiation image.

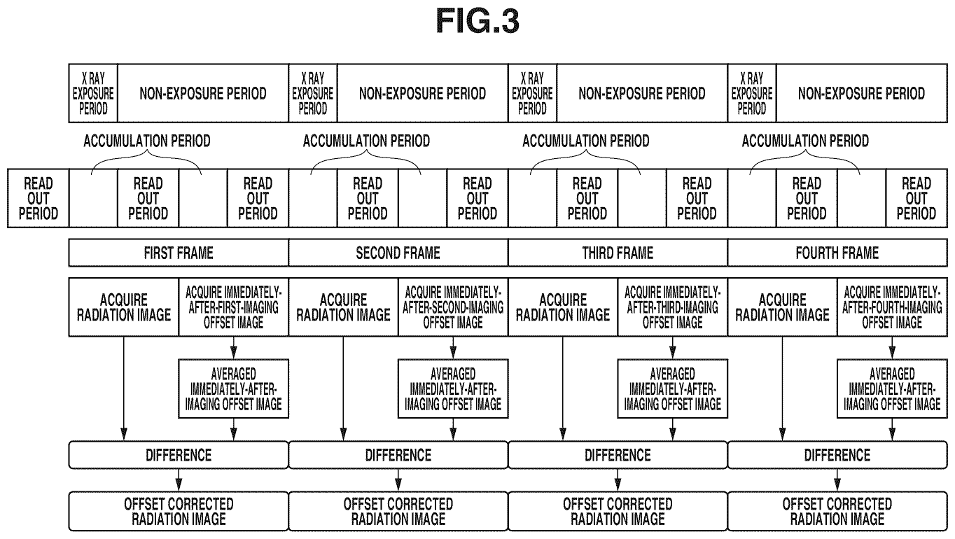

FIG. 3 is a diagram illustrating an averaging intermittent offset correction using a plurality of frames of the radiographic imaging apparatus 100. In the averaging intermittent offset correction using the plurality of frames, as in the intermittent offset correction in the moving image capturing, the radiation image 108 and the immediately-after-imaging offset image 111 are alternately acquired.

In the intermittent offset correction, one immediately-after-imaging offset image 111 is used as the image used for the offset correction, whereas in the averaging intermittent offset correction, an immediately-after-imaging offset image obtained by averaging a previously acquired plurality of immediately-after-imaging offset images 111 is used.

For each frame, the image acquisition unit 102 acquires the radiation image 108 generated by the radiation detection unit 200 when radiation (X rays) is emitted, and the immediately-after-imaging offset image 111 generated immediately after generation thereof by the radiation detection unit 200 when the radiation (X rays) is not emitted.

Then, the image acquisition unit 102 stores the acquired radiation image 108 and the immediately-after-imaging offset image 111 in the storage unit 107.

The offset correction unit 104 acquires the immediately-after-imaging offset image obtained by averaging a previous plurality of frames of the immediately-after-imaging offset images 111. Then, the offset correction unit 104 generates a difference between the radiation image 108 and the averaged immediately-after-imaging offset image for each frame, as an offset corrected radiation image.

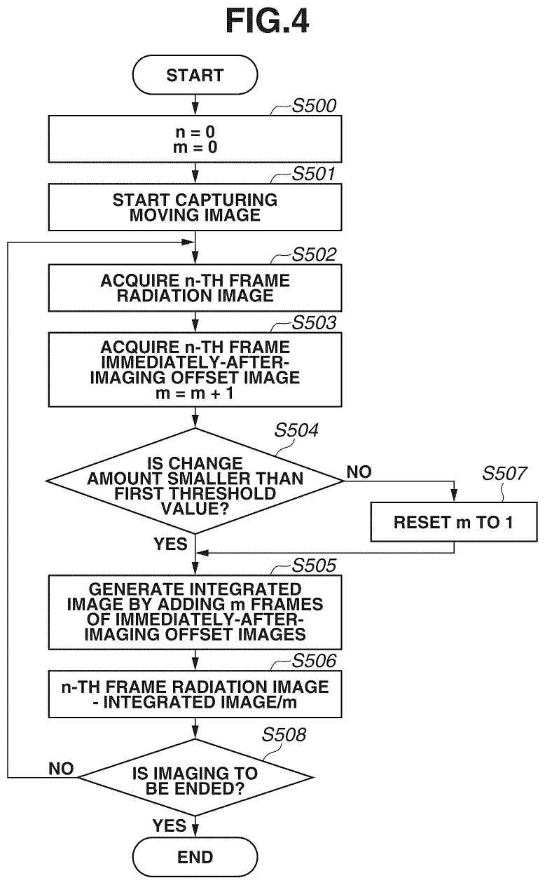

FIG. 4 is a flowchart illustrating a processing method performed by the radiographic imaging apparatus 100 according to the present exemplary embodiment. Hereinbelow, an example of the averaging intermittent offset correction using the plurality of frames in FIG. 3 will be described.

In step S500, the control unit 101 sets a frame number “n” and the number “m” of stored immediately-after-imaging offset images to “0”.

In step S501, the control unit 101 controls the radiation detection unit 200 to start capturing a moving image.

In step S502, the image acquisition unit 102 acquires an n-th frame radiation image 108 generated by the radiation detection unit 200 when the radiation is emitted, and stores it in the storage unit 107.

In step S503, the image acquisition unit 102 acquires an n-th frame immediately-after-imaging offset image 111 generated by the radiation detection unit 200 when the radiation is not emitted, and stores it in the storage unit 107 such that a log thereof is maintained. In this case, for example, the image acquisition unit 102 stores the immediately-after-imaging offset images 111 such that the log of the immediately-after-imaging offset images 111 is maintained for previous five frames. Next, the control unit 101 increments the number “m” of stored immediately-after-imaging offset images 111. For example, the maximum value of “m” is 5.

In step S504, the offset change amount determination unit 106 determines whether a change amount between a previous immediately-after-imaging offset image 111 and a latest immediately-after-imaging offset image 111 is smaller than a first threshold value. For example, in a case where a fourth frame is being captured in FIG. 3, the offset change amount determination unit 106 compares a fourth immediately-after-imaging offset image and a third immediately-after-imaging offset image, or the fourth immediately-after-imaging offset image and a second immediately-after-imaging offset image.

The above-described latest immediately-after-imaging offset image 111 is not limited to the latest one, but may be, for example, one that is a frame before the latest one. The above-described latest immediately-after-imaging offset image 111 is the immediately-after-imaging offset image 111 captured at a first time, and the above-described previous immediately-after-imaging offset image 111 may be the immediately-after-imaging offset image 111 captured at a second time before the first time.

In a case where the offset change amount determination unit 106 determines that the change amount is smaller than the first threshold value (YES in step S504), the processing proceeds to step S505. In a case where the offset change amount determination unit 106 determines that the change amount is not smaller than the first threshold value (NO in step S504), the processing proceeds to step S507.

In step S505, the offset correction unit 104 generates an integrated image obtained by adding “m” frames of the immediately-after-imaging offset images 111 including the latest immediately-after-imaging offset image 111 acquired in step S503 and previous immediately-after-imaging offset images 111.

In step S506, first, the offset correction unit 104 calculates an averaged offset image by dividing the integrated image by “m”. Next, the offset correction unit 104 acquires a difference between the averaged offset image and the n-th frame radiation image 108 as an n-th frame offset corrected radiation image. Then, the processing proceeds to step S508.

However, the immediately-after-imaging offset image 111 sometimes significantly changes due to an image lag caused by high-level radiation exposure or a temperature change in the radiographic imaging apparatus 100. In averaging of the plurality of frames using the immediately-after-imaging offset image 111 including a large change amount, a correct averaged offset image cannot be generated. For this reason, in step S504, in a case where the change amount is determined not to be smaller than the first threshold value (NO in step S504), the processing proceeds to step S507.

In step S507, the offset correction unit 104 changes the number “m” of the stored immediately-after-imaging offset images to 1. Then, the processing proceeds to step S505. In this case, in step S505, since “m” is 1, the offset correction unit 104 determines the latest n-th frame immediately-after-imaging offset image 111 as the integrated image. Then, the processing proceeds to step S506.

In step S506, first, the offset correction unit 104 calculates an averaged offset image by dividing the integrated image by m=1. The averaged offset image becomes the same as the n-th frame immediately-after-imaging offset image 111. Next, the offset correction unit 104 acquires a difference between the n-th frame immediately-after-imaging offset image 111 and the n-th frame radiation image 108 as the n-th frame offset corrected radiation image. This processing is equivalent to the intermittent offset correction in FIG. 2.

In step S508, the control unit 101 determines whether to end the image capturing. In a case where the control unit 101 determines not to end the image capturing (NO in step S508), the control unit 101 increments the frame number “n”, and the processing returns to step S502 to repeat the above-described processing. In a case where the control unit 101 determines to end the image capturing (YES in step S508), the processing in FIG. 4 ends.

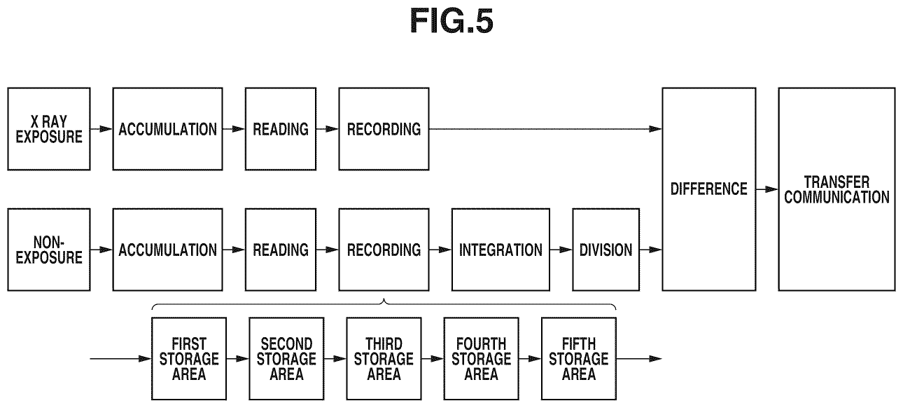

FIG. 5 is a diagram illustrating an example in which the storage unit 107 includes five storage areas. The five storage areas are first to fifth storage areas, and can store five immediately-after-imaging offset images 111.

The upper part in FIG. 5 corresponds to the processing in step S502 in FIG. 4. The radiation generation apparatus 300 controls the radiation source 301 to emit radiation. In this state, the radiation detection unit 200 accumulates a charge generated based on the radiation. The image acquisition unit 102 reads the charge accumulated in the radiation detection unit 200, and records the radiation image 108 in the storage unit 107.

The lower part in FIG. 5 corresponds to the processing in step S503 in FIG. 4. The radiation generation apparatus 300 controls the radiation source 301 not to emit radiation. In this state, the radiation detection unit 200 accumulates a charge. The image acquisition unit 102 moves the previous four frames of the immediately-after-imaging offset images 111 stored in the first to fourth storage areas of the storage unit 107 to the second to fifth storage areas. Then, the image acquisition unit 102 reads the charge accumulated in the radiation detection unit 200 to record the immediately-after-imaging offset image 111 in the first storage area.

In step S505, the offset correction unit 104 generates an integrated image obtained by adding the five frames of the immediately-after-imaging offset images 111 stored in the first to fifth storage areas of the storage unit 107.

In step S506, first, the offset correction unit 104 calculates an averaged offset image by dividing the integrated image by m=5. Next, the offset correction unit 104 acquires a difference between the averaged offset image and the radiation image 108 as an offset corrected radiation image.

The communication unit 113 transmits the offset corrected radiation image to the control apparatus 400.

In FIG. 5, the configuration of the storage unit 107 including five storage areas is illustrated. However, the number thereof is not limited to five. The storage unit 107 is configured to include a plurality of storage areas for the immediately-after-imaging offset images 111, and, for example, in FIG. 5, includes the first to fifth storage areas with a first in first out (FIFO) configuration of the consecutive immediately-after-imaging offset images 111. All the storage areas are reset to “0” at an operation start time.

After the image capturing is started, the image acquisition unit 102 records the latest immediately-after-imaging offset image 111 in the first storage area, moves the immediately-after-imaging offset image 111 previously stored in the first storage area to the second storage area, and moves the immediately-after-imaging offset image 111 previously stored in the second storage area to the third storage area.

Then, the image acquisition unit 102 moves the immediately-after-imaging offset image 111 previously stored in the third storage area to the fourth storage area, and moves the immediately-after-imaging offset image 111 previously stored in the fourth storage area to the fifth storage area. Then, the image acquisition unit 102 deletes the previously recorded oldest immediately-after-imaging offset image 111 previously stored in the fifth storage area.

The above-described implementation method is just an example, and is not limited thereto as long as the plurality of frames can be updated. For example, a ring buffer may be used for the storage unit 107.

The offset correction unit 104 integrates the immediately-after-imaging offset images 111 for the acquired frames, and divides the integrated immediately-after-imaging offset images 111 by the number of acquired frames to generate an averaged immediately-after-imaging offset image.

As described above, the image acquisition unit 102 alternately acquires the radiation image 108 captured in step S502 in the state where the radiation is emitted, and the immediately-after-imaging offset image 111 captured in step S503 in the state where the radiation is not emitted.

First, processing performed in the case where the change amount is determined to be small in step S504 will be described. In this case, in steps S505 and S506, the offset correction unit 104 corrects the one radiation image 108 acquired by the image acquisition unit 102 using an averaged image of the plurality of immediately-after-imaging offset images 111 acquired by the image acquisition unit 102.

More specifically, the offset correction unit 104 obtains a difference between the one radiation image 108 acquired by the image acquisition unit 102 and the averaged image obtained by averaging the plurality of immediately-after-imaging offset images 111 acquired by the image acquisition unit 102, as a radiation image after an offset correction.

Next, processing performed in the case where the change amount is determined to be not small in step S504 will be described. In this case, in steps S505 and S506, the offset correction unit 104 corrects the one radiation image 108 acquired by the image acquisition unit 102 using the one immediately-after-imaging offset image 111 acquired by the image acquisition unit 102.

As described above, according to the present exemplary embodiment, in the case where the change amount between the previous immediately-after-imaging offset image 111 and the latest immediately-after-imaging offset image 111 is smaller than the first threshold value (YES in step S504), the offset correction unit 104 performs the averaging intermittent offset correction in FIG. 3. In the case where the change amount between the previous immediately-after-imaging offset image 111 and the latest immediately-after-imaging offset image 111 is not smaller than the first threshold value (NO in step S504), the offset correction unit 104 performs the intermittent offset correction in FIG. 2.

There is an issue with regard to the intermittent offset correction that random noise is large because the immediately-after-imaging offset image 111 for only one frame is used. According to the present exemplary embodiment, the radiographic imaging apparatus 100 can both reduce the image lag and the random noise by the processing described above.

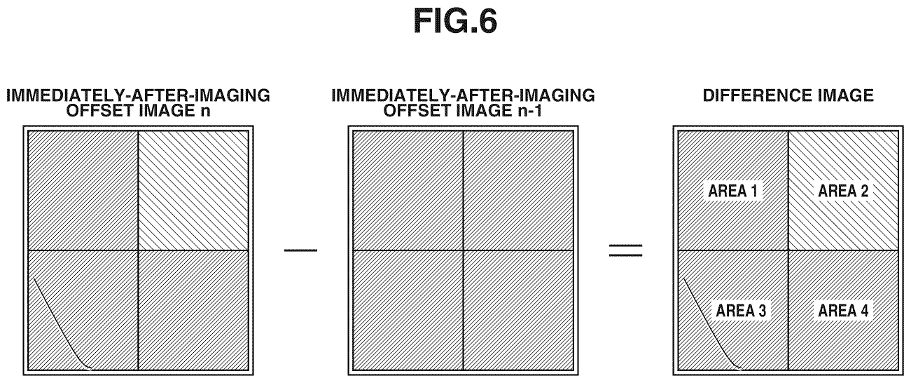

FIG. 6 is a diagram illustrating a processing method performed by a radiographic imaging apparatus 100 according to a second exemplary embodiment. A method of dividing a pixel area of a radiation detection unit 200 into a plurality of areas and checking a change amount in each of the divided areas will be described below.

FIG. 6 illustrates a case where the pixel area of the radiation detection unit 200 is divided into four areas.

The offset change amount determination unit 106 generates a difference image between a previous (n−1)-th frame of the immediately-after-imaging offset image 111 and a latest n-th frame of the immediately-after-imaging offset image 111, and calculates an average value, a maximum value, or a minimum value in each area of the difference image to determine an offset change amount.

The offset change amount determination unit 106 can perform the determination in step S504 based on the average value. For example, in step S504, the offset change amount determination unit 106 generates a difference image between the latest immediately-after-imaging offset image 111 and the previous immediately-after-imaging offset image 111. Then, the offset change amount determination unit 106 compares, for each area, an average value for each area of a plurality of areas obtained by dividing the above-described difference image and 1% of an average value for each area of a plurality of areas obtained by dividing the one radiation image 108 in step S502. The above-described 1% of the average value for each area of the plurality of areas obtained by dividing the above-described radiation image 108 is an example of a second threshold value. The second threshold value may be a value based on the average value for each area of the plurality of areas obtained by dividing the above-described radiation image 108.

For example, the offset change amount determination unit 106 compares the average value for an area 1 obtained by dividing the above-described difference image and 1% of the average value for an area 1 obtained by dividing the above-described one radiation image 108. The offset change amount determination unit 106 compares the average value for an area 2 obtained by dividing the above-described difference image and 1% of the average value for an area 2 obtained by dividing the above-described one radiation image 108. The offset change amount determination unit 106 compares the average value for an area 3 obtained by dividing the above-described difference image and 1% of the average value for an area 3 obtained by dividing the above-described one radiation image 108. The offset change amount determination unit 106 compares the average value for an area 4 obtained by dividing the above-described difference image and 1% of the average value for an area 4 obtained by dividing the above-described one radiation image 108.

The offset change amount determination unit 106 advances the processing to step S507 in a case where the average value for at least any one of the areas among the average values for the plurality of areas obtained by dividing the above-described difference image is not smaller than 1% of the average value for each area of the plurality of areas obtained by dividing the one radiation image 108 (NO in step S504). For example, the offset change amount determination unit 106 determines that the latest immediately-after-imaging offset image 111 has significantly changed (NO in step S504) and advances the processing to step S507 in a case where the average value for the area 2 of the difference image in FIG. 6 is larger than 1% of the average value for the area 2 of the radiation image 108.

The offset change amount determination unit 106 advances the processing to step S505 in a case where average values for all the areas among the average values for the plurality of areas obtained by dividing the above-described difference image are smaller than 1% of average values for the plurality of areas obtained by dividing the above-described one radiation image 108.

In addition, the above-described second threshold value may be 1% of the average value for the one radiation image 108 in step S502. In this case, the offset change amount determination unit 106 advances the processing to step S505 in a case where the average values for all the areas among the average values for the plurality of areas obtained by dividing the above-described difference image are smaller than the second threshold value (YES in step S504). The offset change amount determination unit 106 advances the processing to step S507 in a case where the average value for at least any one of the areas among the average values for the plurality of areas obtained by dividing the above-described difference image is not smaller than the second threshold value (NO in step S504). In the present exemplary embodiment, the second threshold value is, for example, 1% of the average value for the one radiation image 108 in step S502 as described above.

The offset change amount determination unit 106 may perform the determination in step S504 based on the minimum value and the maximum value. In step S504, the offset change amount determination unit 106 generates a difference image between the latest immediately-after-imaging offset image 111 and the previous immediately-after-imaging offset image 111. Then, the offset change amount determination unit 106 compares, for each area, a difference between the minimum value and the maximum value for each area of the plurality of areas obtained by dividing the above-described difference image and 1% of the average value for each area of the plurality of areas obtained by dividing the one radiation image 108 in step S502. The above-described 1% of the average value for each area of the plurality of areas obtained by dividing the radiation image 108 is an example of a third threshold value. The third threshold value may be a value based on the above-described average value for each area of the plurality of areas obtained by dividing the radiation image 108.

The offset change amount determination unit 106 advances the processing to step S507 in a case where the difference between the minimum value and the maximum value for any one of the areas among the differences between the minimum values and the maximum values of the plurality of areas obtained by dividing the above-described difference image is not smaller than 1% of the average value for one of the plurality of areas obtained by dividing the above-described radiation image 108 (NO in step S504). For example, the offset change amount determination unit 106 determines that the latest immediately-after-imaging offset image 111 has significantly changed (NO in step S504) and advances the processing to step S507 in a case where the difference between the minimum value and the maximum value of the area 3 of the difference image in FIG. 6 is larger than 1% of the average value for the area 3 of the radiation image 108.

The offset change amount determination unit 106 advances the processing to step S505 in a case where the differences between the minimum values and the maximum values of all the areas among the differences between the minimum values and the maximum values of the plurality of the areas obtained by dividing the above-described difference image are smaller than 1% of the average values for the plurality of areas obtained by dividing the above-described one radiation image 108 (NO in step S504).

The above-described third threshold value may be 1% of the average value of the one radiation image 108 in step S502. In this case, the offset change amount determination unit 106 advances the processing to step S505 in a case where the differences between the minimum values and the maximum values of all the areas among the differences between the minimum values and the maximum values of the plurality of areas obtained by dividing the above-described difference image are smaller than the third threshold value (YES in step S504). The offset change amount determination unit 106 advances the processing to step S507 in a case where the difference between the minimum value and the maximum value of any one of the areas among the differences between the minimum values and the maximum values of the plurality of areas obtained by dividing the above-described difference image is not smaller than the third threshold value (NO in step S504). The third threshold value is, for example, 1% of the average value for the one radiation image 108 in step S502 as described above.

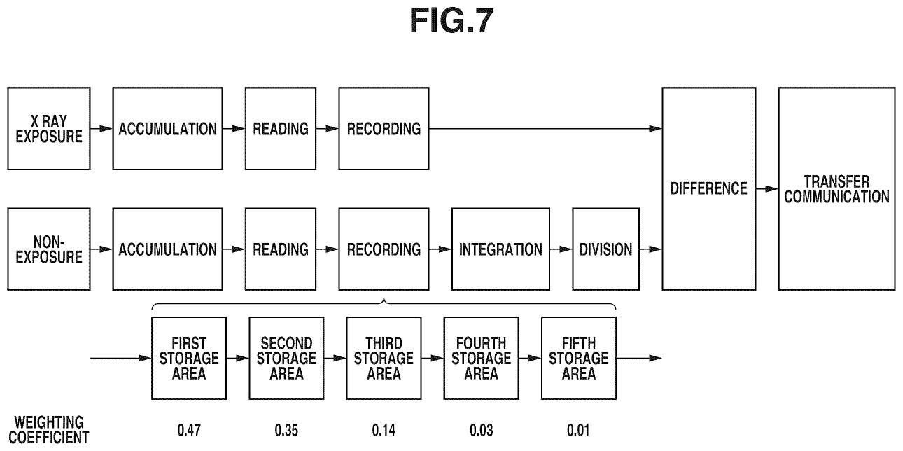

FIG. 7 is a diagram illustrating a processing method performed by a radiographic imaging apparatus 100 according to a third exemplary embodiment. An example of weighting and averaging the previous immediately-after-imaging offset images 111 will be described below.

Even in a case where the offset change amount determination unit 106 compares the latest immediately-after-imaging offset image 111 and the previous immediately-after-imaging offset image 111 and determines that an offset change amount is small, the shift of the immediately-after-imaging offset image 111 tends to become large for an older image.

Thus, in a case where a plurality of consecutive previous frames of the immediately-after-imaging offset images 111 are averaged, it is possible to reduce random noise at a time of averaging and suppress a time-series change by decreasing a weighting coefficient for the older image.

In steps S505 and S506, the offset correction unit 104 multiplies each of five frames of immediately-after-imaging offset images X1 to X5 by the weighting coefficient and adds them to calculate an averaged offset image Y.

$$Y = X 1 \times 0.47 + X 2 \times 0.35 + X 3 \times 0.14 + X 4 \times 0.03 + X 5 \times 0.01$$

In the above formula, the older the immediately-after-imaging offset image is, the smaller the weighting coefficient is, and the weighting coefficient for an immediately-after-imaging offset image X5 is the smallest. Y is a weighted averaged offset image. X1 is a latest immediately-after-imaging offset image 111. X2 to X5 are previous immediately-after-imaging offset images 111.

For example, the weighting coefficient of the immediately-after-imaging offset image X1 is 0.47. The weighting coefficient of the immediately-after-imaging offset image X2 is 0.35. The weighting coefficient of the immediately-after-imaging offset image X3 is 0.14. The weighting coefficient of the immediately-after-imaging offset image X4 is 0.03. The weighting coefficient of the immediately-after-imaging offset image X5 is 0.01.

The offset correction unit 104 may recursively perform calculations by multiplying each of the images X1 to X5 by a coefficient using the latest immediately-after-imaging offset image X1 and the previous immediately-after-imaging offset images X2 to X5 to generate the averaged offset image.

As described above, in steps S505 and S506, the offset correction unit 104 calculates the averaged offset image Y based on the above-described formula. The offset correction unit 104 corrects the one radiation image 108 acquired by the image acquisition unit 102 using the averaged offset image Y obtained by averaging the plurality of immediately-after-imaging offset images X1 to X5 acquired by the image acquisition unit 102 using the weighting coefficients. The weighting coefficients of the plurality of immediately-after-imaging offset images X1 to X5 become smaller as the immediately-after-imaging offset images become older, and the weighting coefficient of the immediately-after-imaging offset image X5 is the smallest.

More specifically, the offset correction unit 104 acquires the difference between the one radiation image 108 acquired by the image acquisition unit 102 and the averaged offset image Y obtained by averaging the plurality of the immediately-after-imaging offset images X1 to X5 acquired by the image acquisition unit 102 using the weighting coefficients, as a radiation image after the offset correction.

As described above, according to the first to third exemplary embodiments, the radiographic imaging apparatus 100 can reduce the image lag and further reduce the random noise using the averaging intermittent offset correction in FIG. 3.

The above-described exemplary embodiments are merely specific examples to implement the present disclosure, and shall not be construed as limiting the technical scope of the present disclosure. Thus, the present disclosure can be realized in diverse ways as long as it is in accordance with the technological thought or main features of the present invention.

According to the present disclosure, it is possible to perform the offset correction that enables the image lag and the random noise to be reduced.

### Other Embodiments

The present disclosure can also be implemented by processing in which a program for implementing one or more functions of the above-described exemplary embodiments is supplied to a system or an apparatus via a network or a storage medium, and one or more processors in a computer of the system or the apparatus read and execute the program. The present disclosure can also be implemented by a circuit (for example, an application specific integrated circuit (ASIC)) for implementing the one or more functions.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-005405, filed Jan. 17, 2024, which is hereby incorporated by reference herein in its entirety.

What is claimed is:

1. A radiographic imaging apparatus comprising:
at least one processor; and
a memory in communication with the at least one processor, the memory storing instructions that, when executed by the at least one processor, cause the at least one processor to function as:
an image acquisition unit configured to alternately acquire a radiation image acquired in a state where radiation is emitted and an offset image acquired in a state where the radiation is not emitted; and
an offset correction unit configured to correct, in a case where a change amount between an offset image acquired at a first time and an offset image acquired at a second time before the first time is smaller than a first threshold value, a radiation image acquired after the first time using a plurality of offset images including the offset image acquired at the first time and the offset image acquired at the second time.

2. The radiographic imaging apparatus according to claim 1, wherein the offset correction unit corrects the radiation image acquired after the first time using the offset image acquired at the first time in a case where the change amount between the offset image acquired at the first time and the offset image acquired at the second time is not smaller than the first threshold value.

3. The radiographic imaging apparatus according to claim 1, wherein the offset correction unit determines whether to correct the radiation image acquired after the first time using the plurality of offset images based on pixel values of a plurality of areas obtained by dividing a difference image between the offset image acquired at the first time and the offset image acquired at the second time or to correct the radiation image acquired after the first time using the offset image acquired at the first time.

4. The radiographic imaging apparatus according to claim 3,
wherein the offset correction unit corrects the radiation image acquired after the first time using the plurality of offset images in a case where an average value for each of all the areas among average values for the plurality of areas obtained by dividing the difference image is smaller than a second threshold value, and
wherein the offset correction unit corrects the radiation image acquired after the first time using the offset image acquired at the first time in a case where an average value for any one of the areas among the average values for the plurality of areas obtained by dividing the difference image is not smaller than the second threshold value.

5. The radiographic imaging apparatus according to claim 3,
wherein the offset correction unit compares, for each of the areas, an average value for each of the plurality of areas obtained by dividing the difference image and a value based on the average value for each of the plurality of areas obtained by dividing the radiation image acquired after the first time,
wherein the offset correction unit corrects the radiation image acquired after the first time using the plurality of offset images in a case where the average values for all the areas among the average values for the plurality of areas obtained by dividing the difference image are smaller than the value based on the average values for the plurality of areas obtained by dividing the radiation image, and
wherein the offset correction unit corrects the radiation image acquired after the first time using the offset image acquired at the first time in a case where the average value for any one of the areas among the average values for the plurality of areas obtained by dividing the difference image is not smaller than the value based on the average values for the plurality of areas obtained by diving the radiation image.

6. The radiographic imaging apparatus according to claim 3,
wherein the offset correction unit corrects the radiation image acquired after the first time using the plurality of offset images in a case where a difference between a minimum value and a maximum value for each of all the areas among differences between minimum values and maximum values for the plurality of areas obtained by dividing the difference image is smaller than a third threshold value, and
wherein the offset correction unit corrects the radiation image acquired after the first time using the offset image acquired at the first time in a case where the difference between the minimum value and the maximum value for any one of the areas among the differences between the maximum values and the maximum values for the plurality of areas obtained by dividing the difference image is not smaller than the third threshold value.

7. The radiographic imaging apparatus according to claim 3,
wherein the offset correction unit compares, for each of the areas, a difference between a minimum value and a maximum value for each of the plurality of areas obtained by dividing the difference image and a value based on an average value for each of the plurality of areas obtained by dividing the radiation image acquired after the first time,
wherein the offset correction unit corrects the radiation image acquired after the first time using the plurality of offset images in a case where the difference between the minimum value and the maximum value for each of all the areas among the differences between the minimum values and the maximum values for the plurality of areas obtained by dividing the difference image is smaller than the value based on the average value for each of the plurality of areas obtained by dividing the radiation image, and
wherein the offset correction unit corrects the radiation image acquired after the first time using the offset image acquired at the first time in a case where the difference between the minimum value and the maximum value for any one of the areas among the differences between the minimum values and the maximum values for the plurality of areas obtained by dividing the difference image is not smaller than the value based on the average value for each of the plurality of areas obtained by diving the radiation image.

8. The radiographic imaging apparatus according to claim 1, wherein the offset correction unit corrects the radiation image acquired after the first time using an image obtained by averaging the plurality of offset images.

9. The radiographic imaging apparatus according to claim 8, wherein the offset correction unit acquires a difference between the radiation image acquired after the first time and the image obtained by averaging the plurality of offset images as a radiation image after an offset correction.

10. The radiographic imaging apparatus according to claim 1, wherein the offset correction unit corrects the radiation image acquired after the first time using an image obtained by averaging the plurality of offset images using weighting coefficients.

11. The radiographic imaging apparatus according to claim 10, wherein the offset correction unit acquires a difference between the radiation image acquired at the first time and the image obtained by averaging the plurality of offset images using the weighting coefficients as a radiation image after an offset correction.

12. The radiographic imaging apparatus according to claim 10, wherein the weighting coefficients of the plurality of offset images are smaller as the offset images are older.

13. A radiographic imaging system comprising:
a radiation generation apparatus configured to generate radiation; and
the radiographic imaging apparatus according to claim 1 communicably connected with the radiation generation apparatus.

14. A method for a radiographic imaging apparatus, the method comprising:
alternately acquiring a radiation image acquired in a state where radiation is emitted and an offset image acquired in a state where the radiation is not emitted; and
correcting, in a case where a change amount between an offset image acquired at a first time and an offset image acquired at a second time before the first time is smaller than a first threshold value, a radiation image acquired after the first time using a plurality of offset images including the offset image acquired at the first time and the offset image acquired at the second time.

15. A non-transitory computer-readable storage medium storing a program for causing a computer to execute the processing method for the radiographic imaging apparatus according to claim 14.
